(19) United States
(12) Patent Application Publication
(10) Pub. No.: US 2018/0010071 A1
(43) Pub. Date: Jan. 11, 2018

(54) METHOD OF ELIMINATING ODOR

(71) Applicant: Scent Control Sciences, LLC, Bedford, IA (US)

(72) Inventor: Brant Fox, Mingo, IA (US)

(21) Appl. No.: 15/206,364

(22) Filed: Jul. 11, 2016

(51) Int. Cl. C11D 3/00; C11D 11/00; C11D 3/39; C11D 3/37; C11D 3/20; C11D 3/10; C11D 3/04; D06F 35/00; C11D 1/22

(52) U.S. Cl. CPC C11D 3/0068; D06F 35/006; C11D 11/0017; C11D 3/3942; C11D 1/22; C11D 3/2086; C11D 3/10; C11D 3/042; C11D 3/3707

(57) ABSTRACT

A method of eliminating odor by utilizing a tablet that is formed from sodium carbonate, sodium percarbonate, polyethylene glycol, and linear alkylbenzene sulfonate. The tablet is dissolved within water in order to form a scent neutralizing solution and then applied to an individual's clothing to eliminate the scent of the individual for hunting purposes.

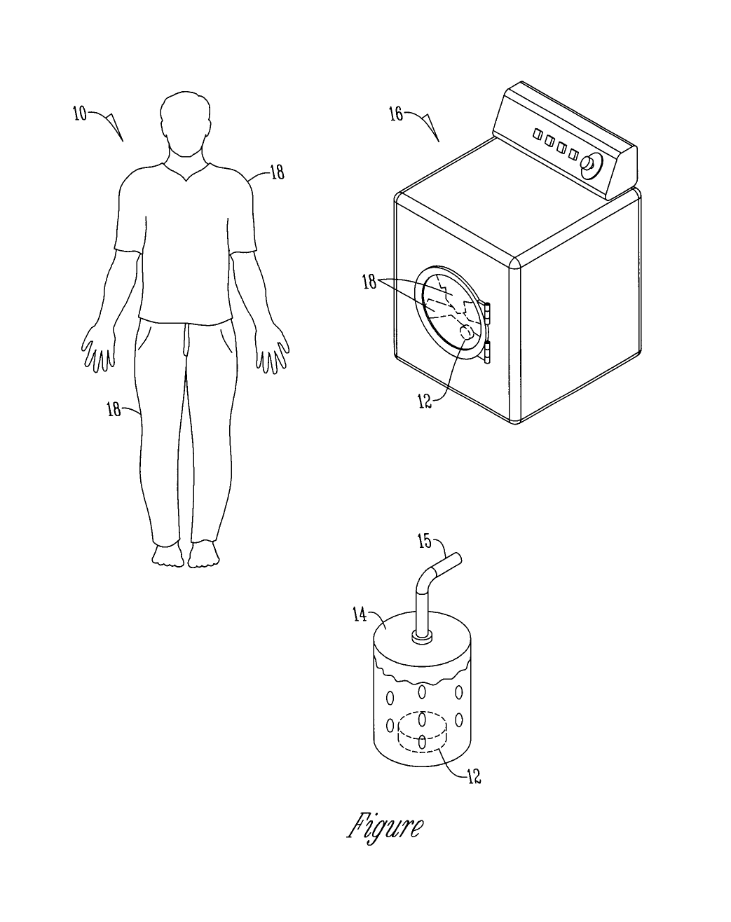

### BACKGROUND OF THE INVENTION

This invention relates to eliminating human odor. More specifically, this invention relates to a tablet utilized to eliminate human scent from clothing for hunting purposes.

Individuals have hunted animals for many years for sport and food. Oftentimes animals such as deer can pick up the scent of hunters causing them to avoid the hunters thus minimizing the chances of a successful hunt. Many methods have been used in order to eliminate these problems including the use of deer urine or the like in order to obscure human scent. Still a need in the art exists for a simple product and method of eliminating scent that can be easily packaged and inexpensive to manufacture.

Thus, a principal object of the present invention is to provide a method of eliminating odor that is cost effective and efficient.

Yet another object of the present invention is to utilize a tablet that dissolves in water to eliminate scent that can be easily carried by an individual.

These and other objects, features, and advantages will become apparent from the specification and claims.

### BRIEF SUMMARY OF THE INVENTION

A method of eliminating odor including forming a tablet that is comprised of sodium carbonate, sodium percarbonate, polyethylene and linear alkylbenzene sulfonate. The tablet is then dissolved in water to form a scent neutralizing solution and the scent neutralizing solution is applied to clothing.

### BRIEF DESCRIPTION OF THE DRAWINGS

The FIGURE is a pictorial representation of an individual utilizing agitation devices.

### DETAILED DESCRIPTION OF THE PREFERRED EMBODIMENT

The FIGURE shows an individual 10 that utilizes a tablet 12 in association with agitation containers such as a bottle 14 with a nozzle 15 for application, a washing machine 16, a glass or the like. The tablet 12 is a scent neutralizing tablet that is designed to dissolve in water to form a scent neutralizing solution that can be placed on clothing 18.

In a first embodiment the table below shows the ingredients and percentage by weight of each ingredient presented during the forming of the tablet.

| Component | Concentration Percentage (by weight) |
|---|---|
| Sodium Carbonate | 25-40% |
| Sodium Percarbonate | 25-35% |
| Citric Acid | 20-30% |
| Polyethylene | 1-5% |
| Linear alkylbenzene sulfonate | 1-5% |

In this embodiment the tablet is best placed in the bottle 14 of water and dissolves in order to form the scent neutralizing solution that can be applied using nozzle 15.

In a second embodiment the tablet 12 is formed by having the following concentration of chemicals.

| Component | Concentration Percentage (by weight) |
|---|---|
| Sodium Carbonate | 10-25% |
| Sodium Percarbonate | 50-60% |
| Boric Acid | 10-20% |
| Polyethylene | 1-5% |
| Linear alkylbenzene sulfonate | 1-5% |
| Ethylenediaminetetraacetate, | 1-10% |
| tetrasodium | |

In this embodiment the tablet 12 is specifically designed for placement into a washing machine 16 for agitation with water and clothing 18. Thus, once the clothing 18 is agitated they may be air dried and scent is removed.

In operation, an individual 10 takes the tablet 12 and places the tablet 12 in a container such as the bottle 14 of water, washing machine 16, glass of water or the like in order to form a scent neutralizing solution. This can be formed by the tablet 12 merely dissolving within the bottle 14 of water or alternatively as a result of agitation of the tablet 12 within water that is within the bottle 14 or washing machine 16. The scent neutralizing solution is then applied to clothing 18 either by the individual by soaking the clothing in the solution through the nozzle 15 of the bottle 14 or alternatively by the clothing 18 soaking in the scent neutralizing solution while in the washing machine 16. After the clothing 18 dries, odor from the clothing is removed such that an individual 10 can wear the clothing 18 while hunting without having a human scent.

Thus, provided is a tablet 12 that is composed of individual chemicals during formation that maximize efficiency of the tablet in forming the scent neutralizing solution, depending on how the solution is made. The tablets are inexpensive and efficiently made as a result of the chemicals that compose the tablet 12. The tablet 12 is additionally non flammable and easy to use by an individual for a quick and simple way of eliminating odor to enhance a hunting experience. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A method of eliminating odor comprising the steps:
forming a tablet comprising sodium carbonate, sodium percarbonate, polyethylene glycol and linear alkylbenzene sulfonate;
dissolving the tablet in water to form a scent neutralizing solution; and
applying the scent neutralizing solution to clothing.

2. The method of claim 1 wherein the tablet further comprises citric acid.

3. The method of claim 2 wherein the tablet comprises by weight 25-40% sodium carbonate, 25-35% sodium percarbonate, 20-30% citric acid, 1-5% polyethylene glycol and 1-5% linear alkylbenzene sulfonate.

4. The method of claim 1 where the tablet further comprises boric acid and ethylenediamineetetracetate tetrasodium.

5. The method of claim 4 wherein the tablet comprises by weight 10-25% sodium carbonate, 50-60% sodium percarbonate, 10-20% boric acid, 1-5% polyethylene glycol, 1-5% linear alkylbenzene sulfonate and 1-10% ethylenediaminetetracetate tetrasodium.

6. The method of claim 5 wherein the tablet is placed in a container with the water and clothing and agitated to dissolve the tablet and apply the scent neutralizing solution to the clothing.

7. The method of claim 6 wherein the container is a washing machine.

8. The method of claim 6 wherein the container is a bottle.
